(19) United States
(12) Patent Application Publication
(10) Pub. No.: US 2007/0239312 A1
(43) Pub. Date: Oct. 11, 2007

(54) System and method for tracking inventory movement using a material handling device

(76) Inventors: Scott P. Andersen, Loveland, OH (US); Vernon M. Peeler, Hopkinsville, KY (US); Gregory J. Castle, Wilder, KY (US); Dan Lafayette, Charlotte, NC (US)

Correspondence Address: INTERNATIONAL PAPER COMPANY, 6285 TRI-RIDGE BOULEVARD, LOVELAND, OH, 45140, US

(21) Appl. No.: 11/400,967

(22) Filed: Apr. 10, 2006

(51) Int. Cl. G06F 7/00

(52) U.S. Cl. 700/213

(57) ABSTRACT

A method of tracking inventory using a material handling device that utilizes a lift mechanism provided on the material handling device for use in transporting an inventory unit from one location to a different location is provided. The method includes moving the lift mechanism using a hydraulic system and generating a signal indicative of hydraulic pressure within a hydraulic line of the hydraulic system. Item information is obtained upon a change in the hydraulic pressure beyond a predetermined threshold value using a reader carried by the material handling device.

### TECHNICAL FIELD

The present application relates to material handling devices and in particular a material handling device capable of detecting a load event.

### BACKGROUND

Material handling devices are frequently employed to move inventory from one position to another, different position. One example of a material handling device is a forklift truck. The forklift truck includes a carrier with forks extending therefrom that are used to engage an inventory unit and lift the inventory unit from, for example, the ground. It has been proposed to provide forklift trucks with systems that monitor conditions of the carrier and forks. For example, the forklift truck may include a height sensor for determining height of the forks. The height determined using the sensor may be displayed to an operator so that the operator can make decisions regarding placement and transport of the inventory unit. Or, the height information may be processed by a computer electronically. It has also been proposed to provide the forklift with a weight sensor for determining weight of a cargo carried by the forklift truck. For a hydraulically powered carriage, this can be accomplished using a pressure sensor located in a hydraulic line that supplies hydraulic fluid to a cylinder that is used to move the carriage vertically.

Accuracy of the weight sensor in determining weight of the cargo carried by the forklift truck can be affected during operation of the forklift truck. For example, sudden vertical accelerations of the forklift truck upward may result in sudden increases in pressure within the hydraulic line, which may appear to the system as an increase in weight. Once the system reaches equilibrium, the pressure may decrease, which may be seen as a decrease in weight carried by the forklift truck. As systems become more automated, greater reliability is desired.

### SUMMARY

In an aspect, a method of tracking inventory using a material handling device that utilizes a lift mechanism provided on the material handling device for use in transporting an inventory unit from one location to a different location is provided. The method includes moving the lift mechanism using a hydraulic system and generating a signal indicative of hydraulic pressure within a hydraulic line of the hydraulic system. Item information is obtained upon a change in the hydraulic pressure beyond a predetermined threshold value using a reader carried by the material handling device.

In another aspect, a method of detecting a load event of a material handling device that utilizes a lift mechanism provided on the material handling device for use in transporting an inventory unit from one location to a different location is provided. The method includes detecting movement of the lift mechanism using a detector. The detector provides an indication to a processor in response to movement of the lift mechanism. A predetermined value is selected based on the indication. An operating condition value of the material handling device is determined. The operating condition value is compared to the predetermined value.

In another aspect, a method of detecting a load event of a material handling device that utilizes a hydraulically controlled lift mechanism provided on the material handling device for use in transporting an inventory unit from one location to a different location is provided. The method includes detecting a cargo pick up or cargo put down event by monitoring hydraulic pressure in a hydraulic system using a pressure detector outputting a signal indicative of hydraulic pressure. The hydraulic system is used to move the lift mechanism between positions. Occurrence of the cargo pick up or cargo put down event is verified by detecting movement of the lift mechanism using a movement detector outputting a signal indicative of movement of the lift mechanism off of a retracted position and detecting movement of a control lever using a detector outputting a signal indicative of a position of the control lever. The control lever provides operator control of movement of the lift mechanism.

In another aspect, a material handling device capable of detecting a load event includes a lift mechanism and a lift control that provides operator control of movement of the lift mechanism. A sensor is capable of generating a signal indicative of an operating condition of the lift mechanism. A reader is configured to obtain information from a transponder using a reader antenna during a reading operation. A processor is connected to the sensor for use in detecting the load event, wherein the processor receives the signal from the sensor and initiates the reading operation when a load event is detected.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective, diagrammatic view of an embodiment of a system and method for use in tracking inventory movement;

FIG. 1A is a diagrammatic view of a rack joist including target;

FIG. 2 is a perspective view of user controls for use in controlling movement of a lift mechanism;

FIG. 3 is a schematic view illustrating various components of the system of FIG. 1;

FIG. 4 illustrates a method for detecting a cargo put down event using the system of FIG. 1;

FIG. 5 illustrates a method for detecting a cargo pick up event using the system of FIG. 1;

FIG. 6 illustrates an embodiment of an inventory unit handling process;

FIG. 7 is a diagrammatic, side view of an embodiment of a material handling device; and

FIG. 8 is a diagrammatic, perspective view of another embodiment of a material handling device.

### DETAILED DESCRIPTION

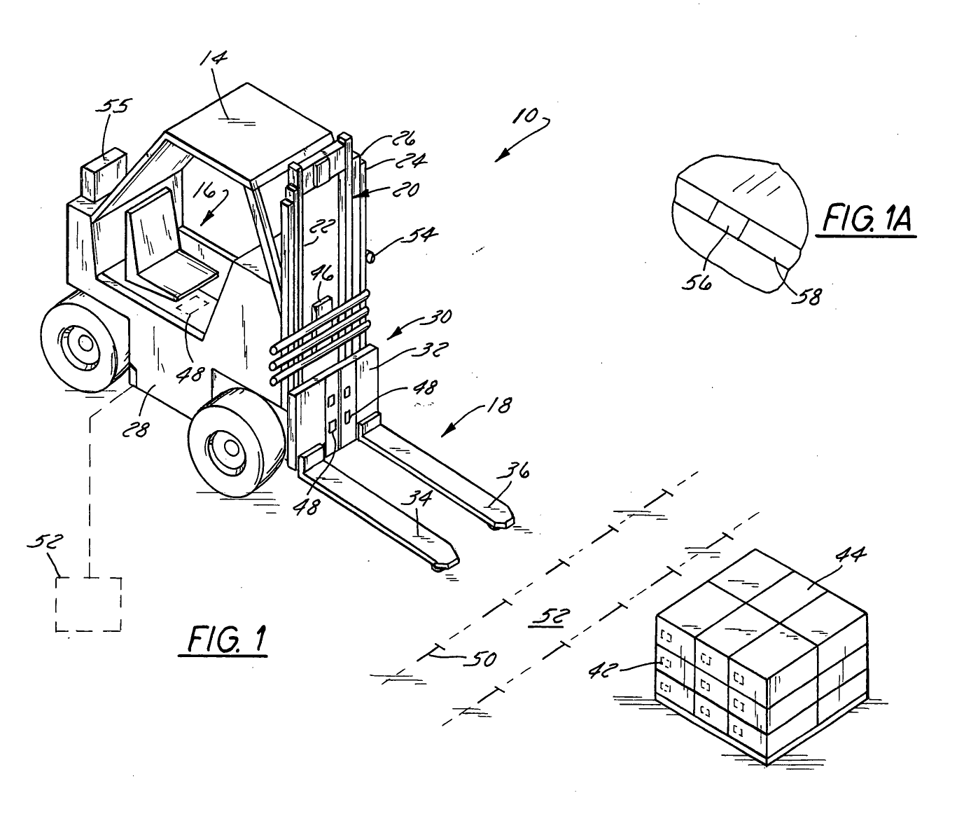

Referring to FIG. 1, a warehouse 10 or other location within a supply chain utilizes a computer-assisted system for tracking inventory movement. The system includes a material handling device, in this example, a vehicle in the form of a forklift truck 14. Forklift truck 14 is capable of detecting a load event, such as a cargo pick up event and a cargo put down event, and issue an indication, for example, to an on-board and/or off-board computer that the load event has occurred. As used herein, the term “cargo pick up event” is broadly used to refer to a loading of a material handling device with cargo (e.g., inventory) and the term “cargo put down event” is broadly used to refer to an unloading of cargo from a material handling device. In some embodiments, the forklift truck 14 can also be used to identify inventory subject to a cargo pick up or put down event, for example, using an automated inventory identification system that will be described in greater detail below.

Forklift truck 14 includes an operator location 16 and a cargo carrying location 18 located forward of the operator location. At the cargo carrying location 18, the forklift truck 14 includes a multi-stage mast 20 with an inner stage 22, an outer stage 24 and an intermediate stage 26. In other embodiments, multi-stage mast 20 may include less than three stages, such as two stages. Outer stage 24 is fixedly mounted to a body 28 of the forklift truck, while the intermediate stage 26 and inner stage 22 are moveable relative to the outer stage in a telescoping-like fashion using chain linkages with the inner stage also being moveable relative to the intermediate stage. Other configurations are possible, such as the inner stage 22 being fixedly mounted to the body 28 with the intermediate and outer stages 26 and 24 being moveable.

Forklift truck 14 includes a power-operated lift mechanism 30 that can be used for moving an inventory unit from one position to a different position during a material handling operation. Lift mechanism 30 is powered hydraulically and includes a carriage 32 and forks 34 and 36 extending outwardly therefrom. Carriage 32 is vertically moveable along the mast 20 for raising and lowering the forks 34 and 36 and cargo carried by the forks. In some embodiments, the lift mechanism 30 may also be tiltable, for example, by tilting the mast 20 (e.g., using a hydraulic tilt cylinder).

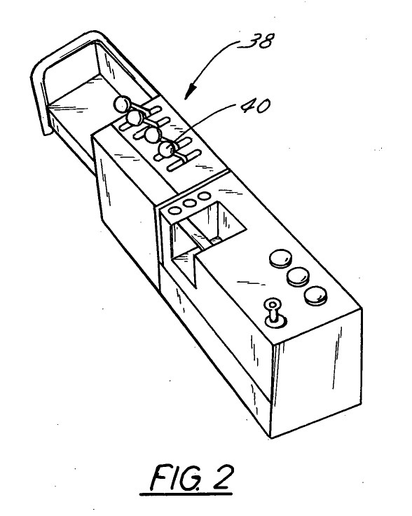

Referring briefly to FIG. 2, movement of the lift mechanism 30 can be controlled by an operator using user controls 38. User controls 38 include a control lever 40 that can be actuated by an operator to initiate movement, up or down, of the carriage 32 and forks 34, 36 along the mast 20. Actuation of the control lever 40 to a cargo lowering position (e.g., forward, toward the cargo carrying location 18) causes the carriage 32 to move vertically downward while movement of the control lever 40 in an opposite direction to a cargo lifting position causes carriage 32 to move vertically upward.

Forklift truck 14 may be moveable using any suitable method and system such as gasoline powered, diesel powered, liquefied petroleum gas powered, compressed natural gas powered, electric power, etc. Internal combustion (IC) counterbalanced trucks (pneumatic or cushion tire), electric counterbalanced trucks, etc. may be utilized. Features of forklift truck 14 may be commercially available and include commercially available control systems, for example, for controlling movement of the lift mechanism 30 and movement of the forklift truck. Exemplary forklift trucks include those commercially available from Hyster Company, such as the S100XM, S120XMS, S135XL2 IC cushion tire lift trucks, the H50XM, H120XM IC pneumatic tire lift trucks, etc., having capacities of about 2,500 lbs. or more, such as about 7,000 lbs. or more, such as about 13,500 lbs. or more.

Referring back to FIG. 1, forklift truck 14 includes an item identification system that is capable of retrieving item information from transponders carried by, for example, inventory, pallets, etc. As used herein, the term “transponder” refers to an electrical device that receives a specific signal and automatically transmits a reply. The reply typically includes item identification information. In the illustrated embodiment, the transponders are RFID tags 42 represented by the dotted lines that include an integrated circuit connected (e.g., electrically coupled, either by direct contact or by capacitive coupling) to an antenna. The integrated circuit may include semiconductor circuits having logic, memory, RF circuitry, and may be a silicon-based chip, a polymer-based chip and the like. Data may be stored in the integrated circuit of the tags 42 (e.g., using EEPROM or SRAM, laser programming, etc.) and can be transmitted through the connected antenna.

The tags 42 may be affixed to components of inventory unit 44 (e.g., a unitized cargo or number of shipping cases) using any suitable process. For example, a pressure sensitive adhesive, or other attachment medium, may be positioned on one side of the tags 42 for use in attaching the tag to a component. In some embodiments, the tags 42 may be applied using glues, hot melts, water activated adhesives, or other adhering mediums. The tags 42 may be applied with an automatic application device, such as a label applicator, which applies the tag to a surface of a component. In some embodiments, a tag 42 may be embedded in a label such as an adhesive-backed label. Such an arrangement may sometimes be referred to as a smart label, which may include a thin tag inlay (i.e., the integrated circuit, substrate and the antenna) embedded in a label which itself may be pre-printed and pre-coded, for example, with a barcode, text, graphics and the like.

In some embodiments, the item identification information may include an electronic product code (EPC) that can be used to identify one or more inventory components of the inventory unit 44 and, in certain implementations, the inventory unit itself. In some instances, the tags 42 may allow the EPC (and other information stored therein) to be changed or added after the tags 42 are manufactured (i.e., the tags may be writable or rewritable as opposed to read-only). However, in many implementations, the tags 42 are read-only. In some implementations, the tags 42 may hold tag manufacturing information such as a manufacturer identity. In some embodiments, the tags 42 may include certain features such as access control features and/or deactivation features and data such as codes associated with these features.

Depending on the application, various types of tags 42 may be used. Tags 42 are typically classified as active or passive. A passive tag has no internal power supply and receives power from an outside source. An active tag includes an internal power source. In some applications, passive tags may be preferred due to, e.g., relatively small size and low cost. In other applications, active tags may be preferred due to relatively long transmit ranges and large memories. Tags 42 may be read-only (i.e., stored data can be read but not changed), writable (i.e., data can be added), rewritable (i.e., data can be changed or re-written), or some combination of each. Suitable, commercially available passive tags 42 may include, for example, an AD-410 single dipole tag (Class 1) available from Avery Dennison, ALN-9340-R “Squiggle™” (Class 1) available from Alien Technology Corporation, Symbol Dual Dipole (Class 0) available from Symbol Technologies, and ALL-9334-02 “2×2” Tag (Class 1) available from Alien Technology Corporation.

Forklift truck 14 serves as a mobile carrier for a reader 46 that is connected to one or more antennas 48 (e.g., 2 or more, such as 4 or 5 antennas or more) for use in interrogating the RFID tags 42 carried by the inventory unit 44. While the antennas 48 and reader 46 are shown carried by the vertically moveable carriage 32, some or all of the antennas and reader 46 may be mounted to fixed portions of the forklift truck 14 that do not move relative to the body 28 of the forklift truck. The reader 46 may be controlled by a processor such as a microprocessor, personal computer, programmable logic controller, mobile computer, etc. that is carried by the vehicle 14. The reader 46 may be used to write data to or change data stored by the tag 42, or the reader may be used only to obtain item identification information from the tags. Any suitable reader 46 may be used. An exemplary reader 46 such as a Model 0101-0092-04 Sensormatic® EPC Reader is commercially available from Tyco International, Ltd or a Model “REAL” EPC Reader (MPR-3118, 3114 or 4114) is commercially available from Applied Wireless ID.

Reader 46 is also connected to a floor antenna 48. Floor antenna 48 is used in interrogating floor RFID tags 50. In some embodiments, the floor tags 50 are embedded in the floor 52. The floor tags 50 may include location determining information that can be processed to determine location of the forklift truck 14. In some embodiments, the floor tags 50 are arranged along strips in the floor 52. Strips of floor tags 50 can be used to determine forklift truck 14 movement into a zone. For example, the floor tags 52 may be positioned about a periphery of a zone delineated by the floor tags so that as the forklift truck 14 crosses the periphery, zone determining information retrieved using the reader 46 and floor antenna 48 may be used to track forklift truck movement into the zone. Tracking forklift truck 14 movement into a zone is described in greater detail in U.S. patent application Ser. No. 11/351,743, filed Feb. 10, 2006, entitled “Inventory Tracking System and Method,” the details of which are hereby incorporated by reference as if fully set forth herein. Various vehicle location tracking systems are described in U.S. patent application Ser. No. 10/369,315, filed Feb. 19, 2003, entitled “RFID Enabled Paper Rolls and System and Method for Tracking Inventory,” the details of which are hereby incorporated by reference as if fully set forth herein. Suitable locating systems and methods include, for example, use of fixed markers, such as RFID tags mounted at fixed positions, position sensors, magnetic tape, triangulating methods, for example, utilizing 80211 technology, non-triangulating systems, global positioning systems (GPS), etc.

Reader 46 is connected to an on-board computer 55 that receives the item information (and location or zone determining information, when applicable) from the reader. In some embodiments, computer 55 is connected to an off-board computer 52 (shown by dotted lines) that receives and/or sends processed item information from and/or to the on-board computer 55.

Forklift truck 14 includes a proximity detector 54, such as a photo eye (e.g., a Model Q45BB6LP Retroreflective-Mode Sensor, commercially available from Banner Engineering Corp., Minneapolis, Minn.), that is capable of providing an indication to the computer 55 and/or 52 that the forklift truck 14 is within a distance (e.g., between about 18 inches to about 48 inches) from a target 56 (FIG. 1A). An exemplary target 56 is Model BRT-THG-2-100 Retroreflective Tape, commercially available from Banner Engineering Corp. The proximity detector 54 is illustrated mounted to a fixed portion of the mast 20, however, the proximity detector 54 may be mounted at a location on the body of the forklift truck 14. In some embodiments, multiple proximity detectors 54 are employed that are carried by the forklift truck 14 and spaced apart vertically from each other. Including multiple, vertically spaced proximity detectors 54 allows for detection of targets 56 located at various elevations.

The proximity detector 54 may be used in a pre-pick up or pre-put down operation, for example, during which identification of products are confirmed using the item identification system described above. As an illustrative example, the target 56 shown in FIG. 1A is attached to a stationary rack joist 58 located near inventory unit 44. The proximity detector 54 of the forklift truck 14 provides a signal to the on-board processor or controller when the proximity detector 54 moves into proximity of the target 56 (e.g., about 18 inches from the target). In some instances, the forks of the forklift truck 14 may be engaged with or in position to pick up (or put down) the inventory unit 44 when the proximity detector 54 is about 18 inches from the target 56. In response to the signal provided by the proximity detector 54, the reader 46 interrogates the product tags 42 of the inventory unit 44. The product identification information retrieved from the product tags 42 are compared to inventory data saved in memory to determine whether the inventory unit 44 in position to be picked up or put down matches a desired inventory unit to be retrieved from or stored at that location or within a particular zone.

As indicated above, forklift truck 14 is capable of detecting a load event, such as a cargo pick up event and a cargo put down event, and issue an indication, for example, to the on-board 55 and/or off-board computer 52 that the load event has occurred. Forklift truck 14 accomplishes load event detection through use of inputs from a pressure transducer integrated into a hydraulic fluid line, a detector that detects mast movement and, in some instances, a detector that detects operator lever position in combination with an algorithm which utilizes the inputs to provide increased reliability in determining whether a load event has occurred.

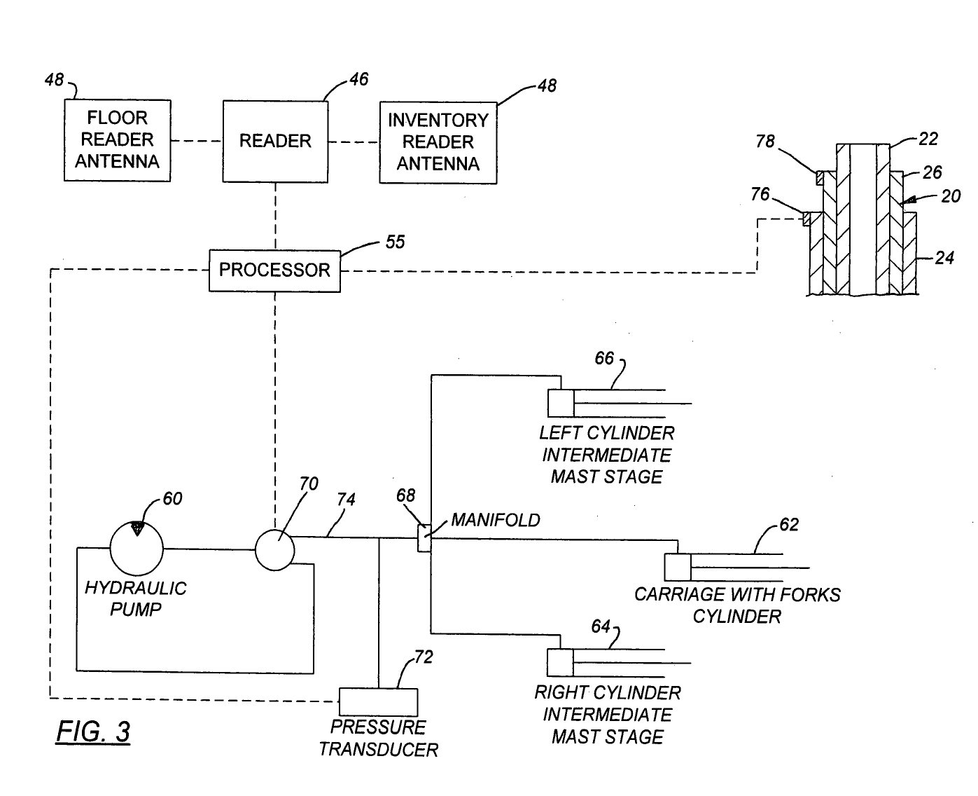

FIG. 3 shows a schematic view of a hydraulic pump 60 that provides pressurized fluid to a set of hydraulic cylinders 62, 64, 66 used to move the lift mechanism 30. Hydraulic cylinder 62 moves the carriage along the inner mast stage 22 and a pair of hydraulic cylinders 64 and 66 that are coupled to the intermediate mast stage 26 move the intermediate mast stage and the inner mast stage 22 using chain linkages. A manifold 68 connects the cylinders 62, 64, 66 to the hydraulic pump 60.

A pressure transducer 72 is located between the manifold 68 and hydraulic pump 60. Pressure transducer 72 is connected to the computer 55 and generates a signal that is indicative of the hydraulic pressure within the hydraulic line 74. The pressure transducer 72 input may be converted into a range of numbers (scaled input). Any suitable transducer 72 may be used and may be selected depending on the type of forklift truck 14 (or other material handling device) employed. Examples of suitable pressure transducers 72 include Model HDA 4475-B transducers, commercially available from Hydac Corp., Bethlehem, Pa.

A control lever assembly includes the control lever 40 and a contact switch, represented by element 70. Contact switch 70 provides a signal to computer 55 when the lever 40 is placed in the put down position. In some embodiments, control lever assembly may provide a signal when the lever 40 is placed in the pick up position, for example, using another contact switch.

A detector 76 is mounted to mast 20 and detects movement of one of the moveable mast stages 22, 26. In particular, detector 76 is mounted to the outer mast stage 24 to detect movement of the intermediate mast stage 26 from a retracted position to off of this retracted position (e.g., binary sensor “on” or “off”). In the illustrated example, detector 76 is a photoreflective sensor (e.g., a Model VS3AP5XLP Photoreflective Polarized sensor, commercially available from Banner Engineering Corp.) and reflector 78 (e.g., a micro-prism reflector or a reflective tag). The detector 76 is mounted to the outer mast stage 24 and reflector 78 is mounted to the intermediate mast stage 26 such that an indication is provided to the computer 55 by the detector when the intermediate mast stage to which the reflector 78 is mounted extends off of the retracted position.

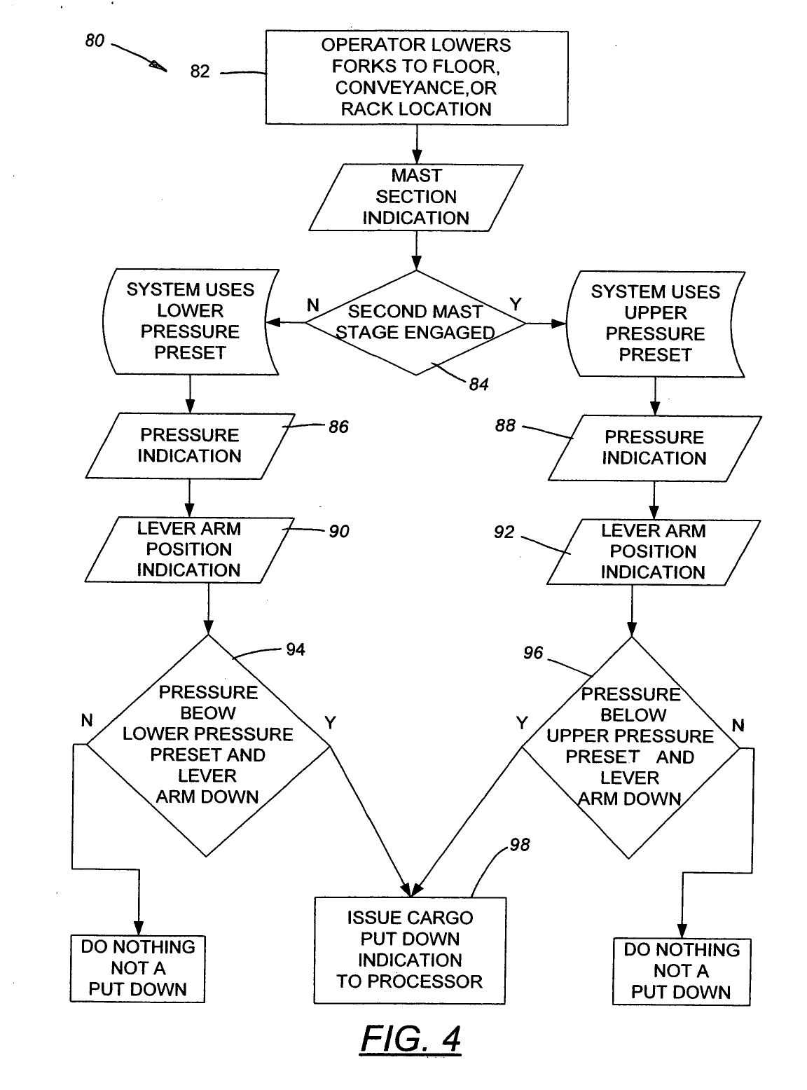

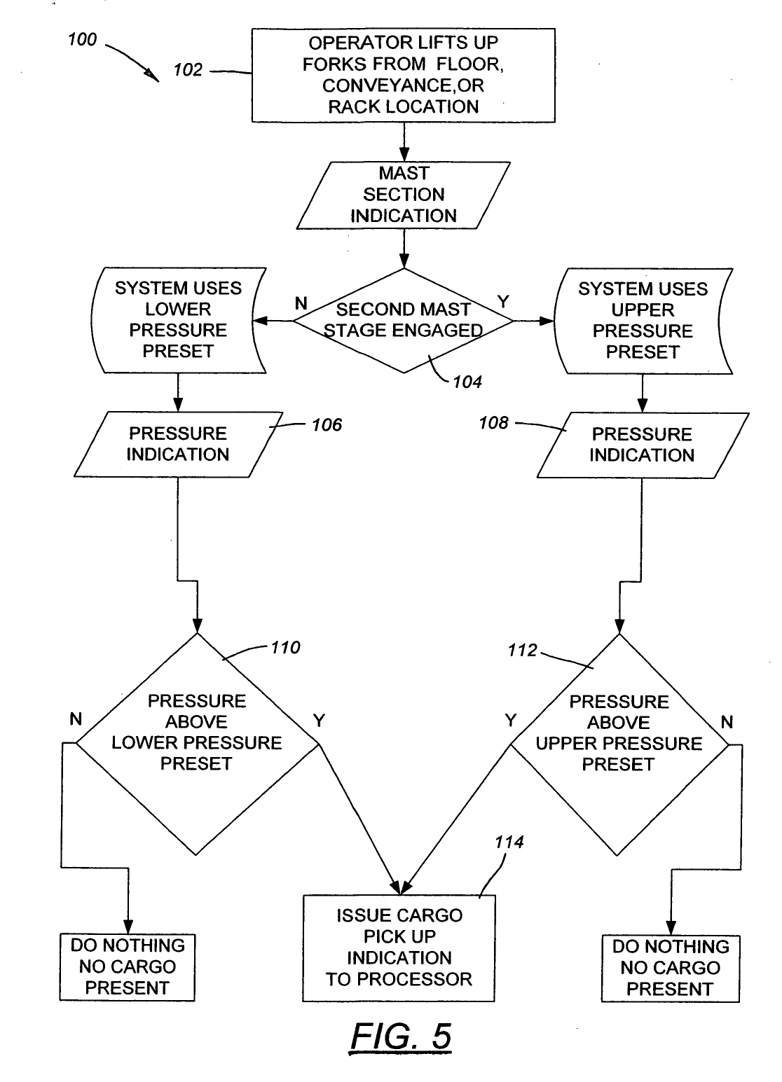

In operation, referring also to FIGS. 4 and 5, a cargo pick up event and cargo put down event are detected through use of inputs from the pressure transducer 72 integrated into the hydraulic fluid line 74, the detector 76 that detects intermediate mast stage 26 movement from the retracted position and, in some instances, the contact switch 70 that detects operator lever position in combination with an algorithm which utilizes the inputs. Referring first to FIG. 4 showing a cargo put down detection process 80, at step 82 the forklift truck operator moves the control lever 40 to the put down position, which causes the lift mechanism to lower the carriage 32 and inventory unit carried by the forks 34, 36. At step 84, the computer 55 determines whether the intermediate mast stage 26 is moving using the detector 76. If the intermediate mast stage 26 is moving, the computer 55 selects a relatively high pressure preset value. Selecting a higher pressure preset value accommodates the higher hydraulic pressures realized in the hydraulic line 74 due to movement of the intermediate 26 and inner 22 mast stages relative to the outer mast stage 24. Alternatively, if it is determined that the intermediate mast stage 26 is not moving (i.e., off of the retracted position), the computer 55 selects a relatively low pressure preset value. Selecting a lower pressure preset value accommodates the lower pressures realized in the hydraulic line 74 when the intermediate 26 and inner 22 mast stages are not being moved relative to the outer mast stage 24.

At steps 86 and 88, the computer 55, using the pressure transducer 72, looks for a drop in pressure in the hydraulic line 74 that is less than the selected pressure preset value. At steps 90 and 92, the computer 55 determines if the control lever 40 is in the put down position. At steps 94 and 96, if the pressure in the hydraulic line is below the selected pressure preset value and the control lever 40 is in the put down position, the computer 55 determines the occurrence of a cargo put down event at step 98.

Referring now to FIG. 5 showing a cargo pick up detection process 100, at step 102 the forklift truck operator moves the control lever 40 to the pick up position, which causes the lift mechanism to lift the carriage 32 and inventory unit carried by the forks 34, 36. At step 104, the computer 55 determines whether the intermediate mast stage 26 is moving using the detector 76. If the intermediate mast stage 26 is moving (i.e., the intermediate mast stage is off of the retracted position), the computer 55 selects a relatively high pressure preset value. As stated above, selecting a higher pressure preset value accommodates the higher hydraulic pressures realized in the hydraulic line 74 due to extension of the intermediate mast stage 26 and the inner mast stage 22 relative to the outer mast stage 24. Alternatively, if it is determined that the intermediate mast stage 26 is not moving, the computer 55 selects a relatively low pressure preset value. Selecting a lower pressure preset value accommodates the lower pressures realized in the hydraulic line 74 when the intermediate mast stage 26 and the inner mast stage 22 are not being moved relative to the outer mast stage 24.

At steps 106 and 108, the computer 55, using the pressure transducer 72, looks for a rise in pressure in the hydraulic line 74 that is greater than the selected pressure preset value. When a pressure is detected within the hydraulic line 74 that is greater than the selected pressure preset value, the computer 55 monitors the pressure within the hydraulic line for a pre-selected time period (e.g., about two seconds). Monitoring the pressure within the hydraulic line 74 for the pre-selected period of time reduces the potential for detection of a false pick up event due to a sudden, unsustained spike in pressure, for example, due to pressure variances while the forklift truck 14 is traveling over terrain. At steps 110 and 112, if the pressure in the hydraulic line is above the selected pressure preset value for the pre-selected time period, the computer 55 determines the occurrence of a cargo pick up event at step 114. If, however, the pressure in the hydraulic line drops below the selected preset value during the pre-selected time period, the computer 55 determines that a pick up event has not occurred. In some embodiments, the computer 55 determines if the control lever 40 is in the pick up position.

It should be noted that the computer 55 may select a different pressure preset value when the movement status of the intermediate mast stage 26 changes. For example, initially, the computer 55 will not detect movement of the intermediate mast stage 26 as the carriage is lifted from the ground within the inner mast stage 22. Thus, at step 104, the computer 55 will select the lower pressure preset value and will look for a pressure reading in the hydraulic line 74 that is higher than the lower pressure preset value using the transducer 72 in detecting a cargo pick up event. However, at some elevation as the carriage moves upward, the intermediate mast stage 26 and inner mast stage 22 will move relative to the outer mast stage 24. This movement of the intermediate mast stage 26 relative to the outer mast stage 224 will be detected using the detector 76 and the computer 55 will select the higher pressure preset value in response to this detection and will look for a pressure reading that is greater than the higher pressure preset value. In some embodiments, the computer 55 will look for a pressure reading that is greater than the higher pressure preset value (or less than the lower pressure preset value) only after a selected time period (e.g., one second, two seconds) upon a change of the movement status of the intermediate mast stage 26 to allow the hydraulic system to stabilize after the intermediate stage is moved off of and/or to the retracted position.

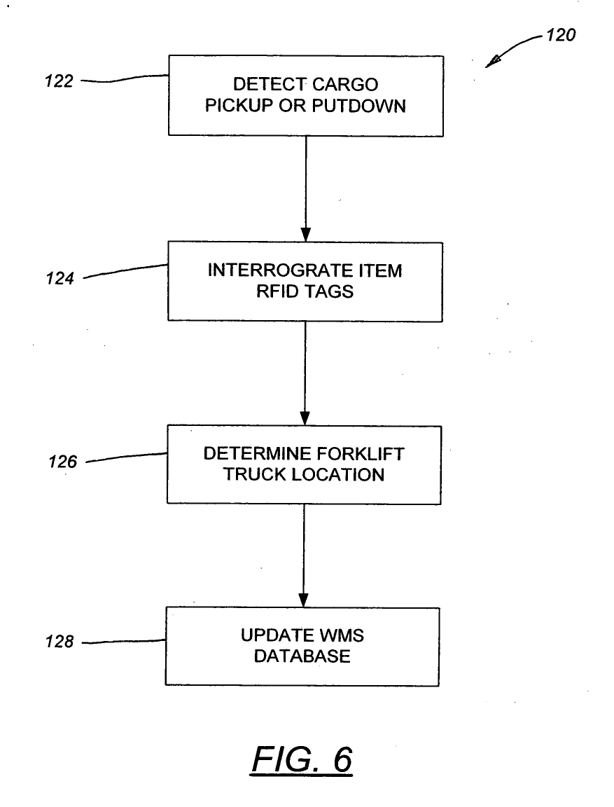

FIG. 6 shows an inventory unit handling process 120 where a warehouse tracking system including the forklift truck 14 reads item identification tags in response to detection of a cargo pick up or put down event. At step 122, a cargo load event is detected, for example, as described above. In response to detection of the cargo load event, item RFID tags are interrogated at step 124 to obtain item identification information, such as EPCs of the inventory picked up or put down. At step 126, location of the forklift truck 14 is determined and product information and location data are updated in a warehouse management system (WMS) database at step 128.

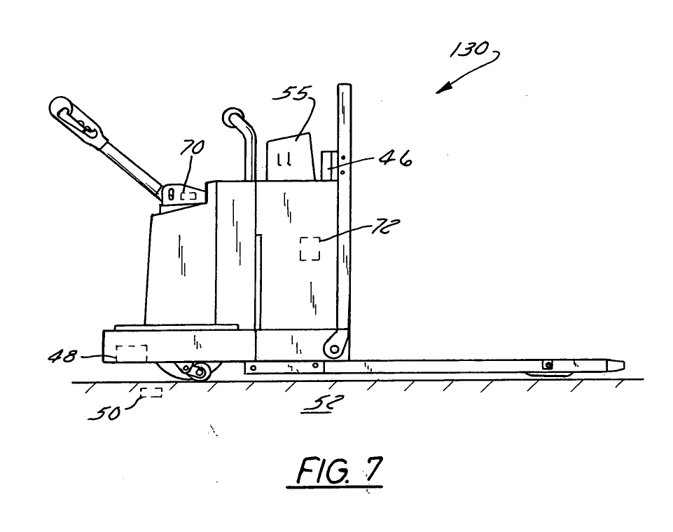

Referring now to FIG. 7, variations on the cargo detection system described above may be used in combination with other types of material handling devices to detect a cargo pick up and put down event. As one example, a walkie 130 (e.g., a Yale Electric Model MPE-080-E, commercially available from Yale Materials Handling Corporation) may include a pressure transducer 72 and a control lever assembly including the contact switch 70 that provide a signal to processor or controller 55 in a fashion similar to that described above. Because the mast of the walkie 130 does not include multiple stages, a detector 76 for detecting mast stage movement is not included. In this embodiment including single stage mast, only a single pressure preset value or range may be utilized where if the pressure detected using the pressure transducer falls below the pressure preset value for a pre-selected time period and the control lever is located in the put down position, a cargo put down event is detected and if the pressure detected rises above the pressure preset value for the pre-selected time period a cargo pick up event is detected. As above, the controller 55 may signal the reader 46 to interrogate item RFID tags using antenna 48 to obtain product identification information.

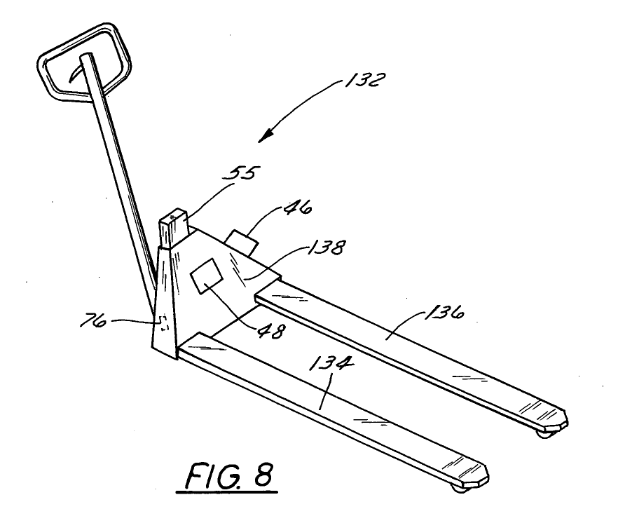

In another embodiment, a pallet jack 132 (see FIG. 8) may include a detector 76 (shown in dotted lines) for use in detecting a cargo load event. Because the pallet jack 132 is not hydraulically powered, it does not include a pressure transducer. The detector 76 provides a signal to the controller 55 when chassis 138 including forks 134 and 136 are moved from the illustrated put down position, indicating a cargo pick up event.

The systems and methods described above can be utilized to provide a number of benefits in real time, including the ability to track the location of inventory, improve warehouse utilization, improve the placement of inventory, provide independent shipment verification, and provide an electronic physical inventory. The systems and methods may be used to identify and track a variety of inventoried products for a variety of industries.

A number of detailed embodiments have been described. Nevertheless, it will be understood that various modifications may be made. Accordingly, other embodiments are within the scope of the following claims.

What is claimed is:

1. A method of tracking inventory using a material handling device that utilizes a lift mechanism provided on the material handling device for use in transporting an inventory unit from one location to a different location, the method comprising:
moving the lift mechanism using a hydraulic system;
generating a signal indicative of hydraulic pressure within a hydraulic line of the hydraulic system; and
obtaining item information upon a change in the hydraulic pressure beyond a predetermined threshold value using a reader carried by the material handling device.

2. The method of claim 1 further comprising processing the signal indicative of hydraulic pressure using a processor to detect the change in the hydraulic pressure and to determine whether the change is beyond the predetermined threshold value, the signal being generated by a pressure transducer incorporated into the hydraulic line.

3. The method of claim 2 comprising directing the reader to obtain item information using the processor upon the change in hydraulic pressure detected using the processor.

4. The method of claim 3 further comprising detecting position of a control lever used to control movement of the lift mechanism.

5. The method of claim 4 further comprising detecting movement of the lift mechanism using a detector, the detector providing an indication to the processor in response to movement of the lift mechanism.

6. The method of claim 5, wherein the step of processing the signal indicative of hydraulic pressure to detect the change in hydraulic pressure is performed only after a pre-selected period of time after movement of the lift mechanism is detected.

7. The method of claim 2 comprising monitoring the signal to determine whether the change in hydraulic pressure beyond the predetermined threshold value occurs for a pre-selected time period.

8. The method of claim 1, wherein item information is obtained from an RFID tag.

9. The method of claim 1 further comprising
obtaining location information using a locating system; and
processing the location information and item information to update a warehouse management system.

10. The method of claim 9, wherein the step of obtaining location information includes scanning a floor RFID tag using the reader.

11. The method of claim 9, wherein the step of obtaining location information is implemented using a global positioning system.

12. A method of detecting a load event of a material handling device that utilizes a lift mechanism provided on the material handling device for use in transporting an inventory unit from one location to a different location, the method comprising:
detecting movement of the lift mechanism using a detector, the detector providing an indication to a processor in response to movement of the lift mechanism;
selecting a predetermined value based on the indication;
determining an operating condition value of the material handling device; and
comparing the operating condition value and the predetermined value.

13. The method of claim 12, wherein the lift mechanism comprises
a mast; and
a carriage the moves along the mast.

14. The method of claim 13, wherein the step of detecting movement of the lift mechanism comprises detecting movement of a mast stage, the mast comprising more than one mast stage.

15. The method of claim 13, wherein the predetermined value is a pressure value, the step of determining an operating condition value comprising determining hydraulic pressure in a hydraulic system using a pressure transducer that outputs a signal indicative of hydraulic pressure in the hydraulic system, the hydraulic system being used to move the lift mechanism.

16. The method of claim 15, wherein the step of determining hydraulic pressure is performed after movement of the lift mechanism is detected.

17. The method of claim 16, wherein the step of comparing the operating condition value and the pressure value is performed a pre-selected time period after movement of the lift mechanism is detected.

18. The method of claim 16, wherein the processor determining that the hydraulic pressure is greater than the predetermined pressure value.

19. The method of claim 15 further comprising automatically obtaining item information when the processor determines that a cargo pick up or a cargo put down event has occurred.

20. The method of claim 19 further comprising detecting position of a control lever using a detector that outputs a signal responsive to a position of the control lever to the processor, the control lever being used to control movement of the lift mechanism by a user.

21. The method of claim 20 comprising determining whether the hydraulic pressure determined is less than the predetermined pressure value using the processor, wherein when the processor determines that the hydraulic pressure is less than the predetermined pressure value and that the control lever is in a put down position using the detector that outputs a signal responsive to a position of the control lever, determining that a cargo put down event has occurred.

22. The method of claim 19, wherein the item information is automatically obtained using a reader carried by the material handling device.

23. The method of claim 22 further comprising
obtaining location information using a locating system; and
processing the location information and the item information when the processor determines that a cargo pick up or a cargo put down event has occurred.

24. The method of claim 23, wherein the step of obtaining location information comprises scanning a floor RFID tag using the reader.

25. The method of claim 23, wherein the step of obtaining location information is implemented using a global positioning system.

26. The method of claim 12 further comprising performing a pre-load event process, the pre-load event process comprising determining when the material handling device is within a predetermined distance from a target using a proximity detector.

27. A method of detecting a load event of a material handling device that utilizes a hydraulically controlled lift mechanism provided on the material handling device for use in transporting an inventory unit from one location to a different location, the method comprising:
detecting a cargo pick up or cargo put down event by monitoring hydraulic pressure in a hydraulic system using a pressure transducer outputting a signal indicative of hydraulic pressure, the hydraulic system used to move the lift mechanism between positions; and
verifying occurrence of the cargo pick up or cargo put down event by detecting movement of the lift mechanism using a position detector outputting a signal indicative of movement of the lift mechanism off of a retracted position and detecting position of a control lever using a detector outputting a signal indicative of a position of the control lever, the control lever providing operator control of movement of the lift mechanism.

28. A material handling device capable of detecting a load event, the material handling device comprising:
a lift mechanism;
a lift control that provides operator control of movement of the lift mechanism;
a sensor capable of generating a signal indicative of an operating condition of the lift mechanism;
a reader configured to obtain information from a transponder using a reader antenna during a reading operation; and
a processor connected to the sensor for use in detecting the load event;
wherein the processor receives the signal from the sensor and initiates the reading operation when a load event is detected.
